(19) United States
(12) Patent Application Publication
(10) Pub. No.: US 2003/0053720 A1
(43) Pub. Date: Mar. 20, 2003

(54) Continuous strip of plastic bags, method and apparatus for making same, and novel plastic bag constructions

(76) Inventors: Sol Smith, West Bloomfield, MI (US); Benjamin J. Barish, Tel Aviv (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(21) Appl. No.: 10/244,183

(22) Filed: Sep. 16, 2002

Related U.S. Application Data
(60) Provisional application No. 60/322,741, filed on Sep. 18, 2001.
(60) Provisional application No. 60/324,537, filed on Sep. 26, 2001.
(60) Provisional application No. 60/330,480, filed on Oct. 23, 2001.
(60) Provisional application No. 60/334,601, filed on Dec. 3, 2001.

(51) Int. Cl. B65D 33/00; B31B 1/64; B31B 49/04

(52) U.S. Cl. 383/35; 493/199; 493/212

(57) ABSTRACT

A continuous strip of individually severable plastic bag includes a flattened, hollow, tubular structure of a thin plastic material formed with a plurality of longitudinally-spaced transverse bond lines to define closed bottoms of plastic bags when individually severed from the continuous strip, with a transverse severance line on one side of each transverse bond line to permit severance of an individual plastic bag, and with a pair of finger tabs adjacent each transverse severance line to facilitate opening a plastic bag when severed from the continuous strip. Several preferred embodiments are described wherein the finger tabs are integrally formed with the continuous strip, and wherein they are formed as separate elements bonded to the continuous strip.

The present application is related to, and claims the priority dates of, Provisional Applications: No. 60/322,741 filed Sep. 18, 2001, No. 60/324,537 filed Sep. 26, 2001, No. 60/330,480 filed Oct. 23, 2001, and No. 60/334,601 filed Dec. 3, 2001.

### FIELD AND BACKGROUND OF THE INVENTION

The present invention relates to a continuous strip of individually severable plastic bags, to a method and apparatus for making such continuous strips, and to novel plastic bag constructions.

Continuous strips of severable plastic bags made of thin plastic film are widely available in roll form for a variety of uses. The user, when desiring to remove a plastic bag from the continuous strip, must first locate the transverse severance line for the bag, sever the bag from the continuous strip, locate the open top of the severed bag as distinguished from its closed bottom, and finally separate the two sides of the open top of the severed bag from each other in order to open the bag. Locating the severance line for severing the bag, and then locating the open top of the severed bag, can be somewhat troublesome since the severance lines are very fine, and the open top may be at either end of the severed bag, according to the construction of the particular roll. Particularly awkward is the opening of such a plastic bag because of the thinness of the plastic films presently being used, and the tendency of such films to firmly adhere to each other.

### OBJECTS AND BRIEF SUMMARY OF THE INVENTION

One object of the present invention is to provide a continuous strip of individually severable plastic bags having advantages in the above respects. More particularly, an object of the invention is to provide a continuous strip of individually severable plastic bags in which the severance line for severing a plastic bag may be conveniently located, and in which a plastic bag, after being severed, may be conveniently opened. Further objects of the invention are to provide a method and apparatus for making such continuous strips of plastic bags, and also to provide novel constructions of plastic bags.

According to one aspect of the present invention, there is provided a continuous strip of individually-severable plastic bags, comprising: a flattened, hollow, tubular structure of plastic film formed with a plurality of transversely-extending, longitudinally-spaced bond lines to define the closed bottoms of the plastic bags when individually severed from the continuous strip; the flattened, hollow, tubular structure also being formed with a transversely-extending severance line on one side of each transversely-extending bond line to permit severance of an individual bag from the continuous strip, and to define the open top of the plastic bag severed from the continuous strip; and a pair of finger tabs carried by the continuous strip adjacent each of the transversely-extending severance lines to facilitate opening each plastic bag when severed from the continuous strip.

According to further features in some described preferred embodiments, the finger tabs are integrally formed with the plastic film and are defined by continuous cut lines therein.

Other embodiments are described below wherein the finger tabs are separate elements bonded to the continuous strip.

As will be described more particularly below, continuous strips of plastic bags made in accordance with the foregoing features not only facilitates locating the severance line for severing a bag and the open end of each plastic bag after being severed from the continuous strip, but also facilitates opening the severed plastic bag since it is only necessary to grasp the two flexible tabs and to pull them apart.

According to another aspect of the invention, there is provided a method of making a continuous strip of individually severable plastic bags, comprising: forming a plurality of longitudinally-spaced transverse bond lines in a flattened, hollow, tubular structure of a thin plastic material, to define closed bottoms of plastic bags when individually severed from the continuous strip; forming a transverse severance line on one side of each transverse bond line to permit severance of an individual bag, and to define the top of the next unsevered plastic bag in the continuous strip; and providing a pair of finger tabs adjacent each of the severance lines to facilitate opening of each plastic bag when severed from the continuous strip.

According to a still further aspect of the invention, there is provided apparatus for producing continuous strips of individually severable plastic bags, comprising: a pair of forming members spaced from each other to engage the opposite faces of a flattened, hollow, tubular structure fed as a continuous strip between the forming members; the outer surfaces of the forming members being constructed to form: a plurality of transversely-extending longitudinally-spaced bond lines to define closed bottoms of the plastic bags when individually severed from the continuous strip; a transversely-extending severance line on one side of each transversely-extending bond line to permit severance of an individual bag from the continuous strip, and to define the open top of the plastic bag severed from the continuous strip; and a pair of finger tabs carried by the continuous strip adjacent each of the transversely-extending severance lines to facilitate opening each plastic bag when severed from the continuous strip.

In one described preferred embodiment, the forming members are drums rotatably mounted along parallel axes; and in another described embodiment, the forming members include a reciprocating plate overlying the continuous strip, and a table underlying the continuous strip.

According to yet another aspect of the invention, there is provided a plastic bag open at one end and having, at the open end, a pair of finger tabs to facilitate opening the plastic bag.

As will be described below, the foregoing method and apparatus may be used in making continuous strips of individually severable plastic bags from flattened, hollow, tubular structures of the seamed type, or of the unseamed type such as produced by extrusion or air-blowing techniques now commonly used for making thin plastic bags.

Further features and advantages of the invention will be apparent from the description below.

### BRIEF DESCRIPTION OF THE DRAWINGS

The invention is herein described, by way of example only, with reference to the accompanying drawings, wherein:

FIG. 1 is a diagram illustrating one type of apparatus for producing continuous strips of individually severable plastic bags in accordance with the present invention;

FIG. 2 is a fragmentary view illustrating one form of continuous strip of plastic bags constructed in accordance with the apparatus of FIG. 1;

FIG. 3 is an enlarged sectional view along line III-III of FIG. 1;

FIG. 4 is an enlarged fragmentary view of FIG. 2;

FIG. 5 is a diagram illustrating another manner of producing continuous strips of individually severable plastic bags in accordance with the invention;

FIGS. 6a and 6b are fragmentary views illustrating two forms of finger tabs produced in a continuous strip of plastic bags constructed in accordance with the method of FIG. 5;

FIG. 7 is a sectional view along line VII-VII of FIG. 6a;

FIG. 8 is a fragmentary view illustrating another form of continuous strip of plastic bags constructed in accordance with the present invention;

FIG. 9 is a sectional view along line IX-IX of FIG. 8;

FIG. 10 is a fragmentary view similar to that of FIG. 8 but illustrating a modification in the construction of the finger tabs to enable them also to be used as ties cords for closing the bags;

FIG. 11 is a diagrammatic view illustrating another type of apparatus for producing the continuous strip of plastic bags of FIG. 8 or FIG. 10;

FIG. 12 diagrammatically illustrates a further type of apparatus for producing another form of continuous strip in accordance with the present invention;

FIG. 13 illustrates one form of continuous strip produced with the apparatus of FIG. 12;

FIG. 14 illustrates one of the plastic bags after severing from the continuous strip of FIG. 13;

FIG. 15 is a flow chart illustrating the manner of producing the continuous strip of plastic bags of FIGS. 12-14;

FIG. 16 diagrammatically illustrates a still further type of apparatus for producing continuous strips of plastic bags in accordance with the present invention;

FIGS. 17a and 17b are fragmentary views illustrating the continuous strip at points immediately upstream and downstream, respectively, of the deflector in FIG. 16;

FIG. 18 illustrates one of the bags in the continuous strip produced with the apparatus of FIG. 16 after severed from the continuous strip; and

FIG. 19 diagrammatically illustrates apparatus similar to that of FIG. 18 but including a reciprocating plate instead of rotatable drums.

### DESCRIPTION OF PREFERRED EMBODIMENTS

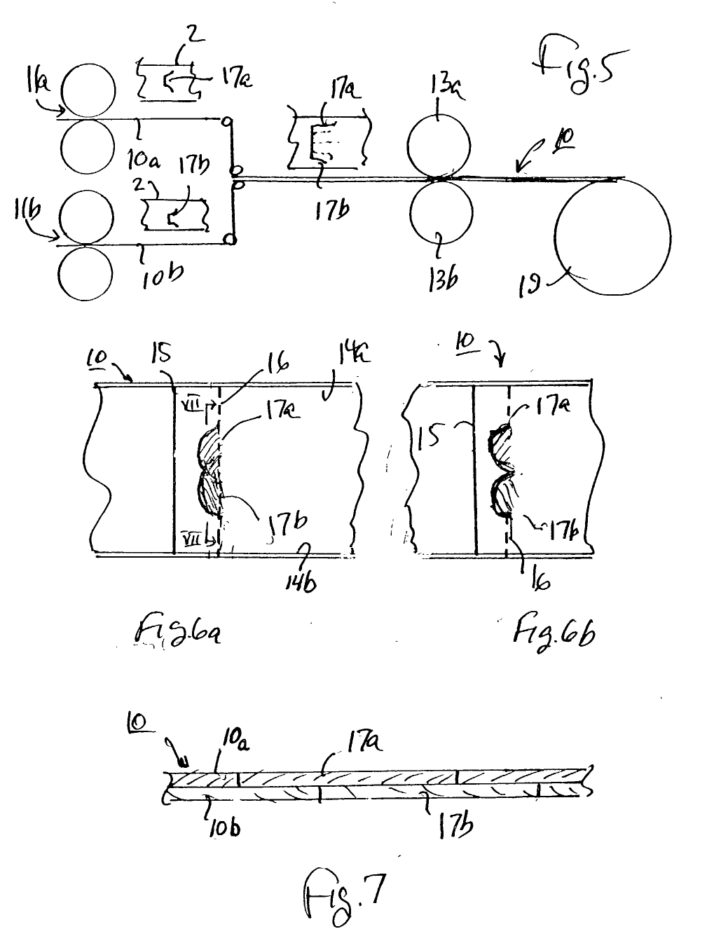

The Embodiments of FIGS. 1-7

FIGS. 1-7 illustrate embodiments of the invention wherein the plastic film used for making the continuous strip of individually severable plastic bags is integrally formed with a pair of finger tabs for each plastic bag by cut lines in the plastic film.

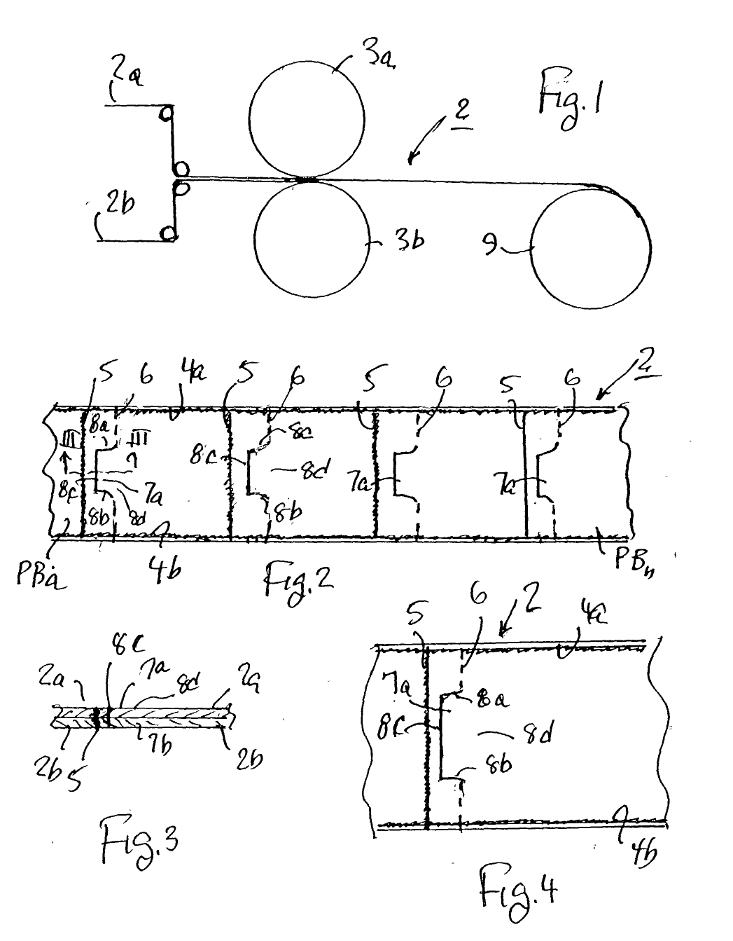

As shown particularly in FIG. 1, the continuous strip, generally designated 2, is made of a pair of plastic films 2a, 2b passing between a pair of drums 3a, 3b having their outer surfaces structured to product the continuous strip illustrated in FIG. 2. Thus, the two drums 3a, 3b are constructed to define a pair of longitudinally-extending continuous bond lines 4a, 4b along the opposite longitudinal edges of the two films 2a, 2b; a plurality of transversely-extending, longitudinally-spaced, continuous bond lines 5; and a plurality of transversely-extending severance lines 6, each adjacent to and on one side of one of the transverse bond lines 5. The two longitudinal bond lines 4a, 4b define a flattened, hollow, tubular structure with longitudinal seams; the transverse bond lines 5 define the closed bottoms of the plastic bags PBa-PBn in the continuous strip; and the transverse severance lines 6 define the open ends of the plastic bags after each has been severed from the continuous strip along the severance lines.

To facilitate the opening of each plastic bag after severed along the transverse severance lines 6, the continuous strip 2 is integrally formed with a pair of opposed finger tabs 7a, 7b (FIGS. 2, 3) on the same side of each transverse bond line 5 as the transverse severance lines 6. As shown particularly in FIG. 2 with respect to finger tab 7a, each finger tab is defined by three cut lines 8a, 8b, 8c along three sides of the finger tab, the fourth side being uncut to define a connecting web 8d with the respective plastic bag.

In the construction illustrated in FIG. 2, the transverse severance lines 6 are joined to the inner ends of the cut lines 8a, 8b. In such a construction, the so-formed finger tabs 7a, 7b project axially from the top edge of the open end of each plastic bag when severed from the continuous strip and are in superposed aligned relationship with each other.

The continuous strip 2, when so formed, is wound on a take-up roller or drum 9.

In the above-described embodiment of the invention, as well as those described below, the finger tabs may be distinctly colored from the remainder of the continuous strip to better enable the user to see the finger tabs after a plastic bag has been severed from the continuous strip.

It will thus be seen that when a continuous strip 2 of a plurality of severable plastic bags PBa-PBn is formed as described above, each plastic bag may be individually severed from the continuous strip along its respective transverse severance line 6. When a plastic bag is so severed from the continuous strip, one end of the severed bag is open along the severance line 6, whereas the opposite end of the bag is closed by the transverse bond line 5. The open end of the bag carries the two finger tabs 7a, 7b, thereby enabling the user to quickly recognize that end of the bag and to distinguish it from the closed end defined by the transverse bond line 5. In addition, the tabs 7a, 7b may be grasped by the user's fingers and pulled apart, thereby enabling the user to fully-open that end of the bag in a convenient and quick manner even when the two sides of the severed bag firmly adhere to each other.

FIGS. 5-7 illustrate an embodiment of the invention wherein the finger tabs corresponding to tabs 7a, 7b in FIGS. 1-4, instead of being in superposed aligned relationship to each other as described above, are in a partially-overlapping (FIG. 6a) or non-overlapping (FIG. 6b) relationship to each other. This better facilitates grasping the finger tabs and opening the respective bag when the bag is severed from the continuous strip.

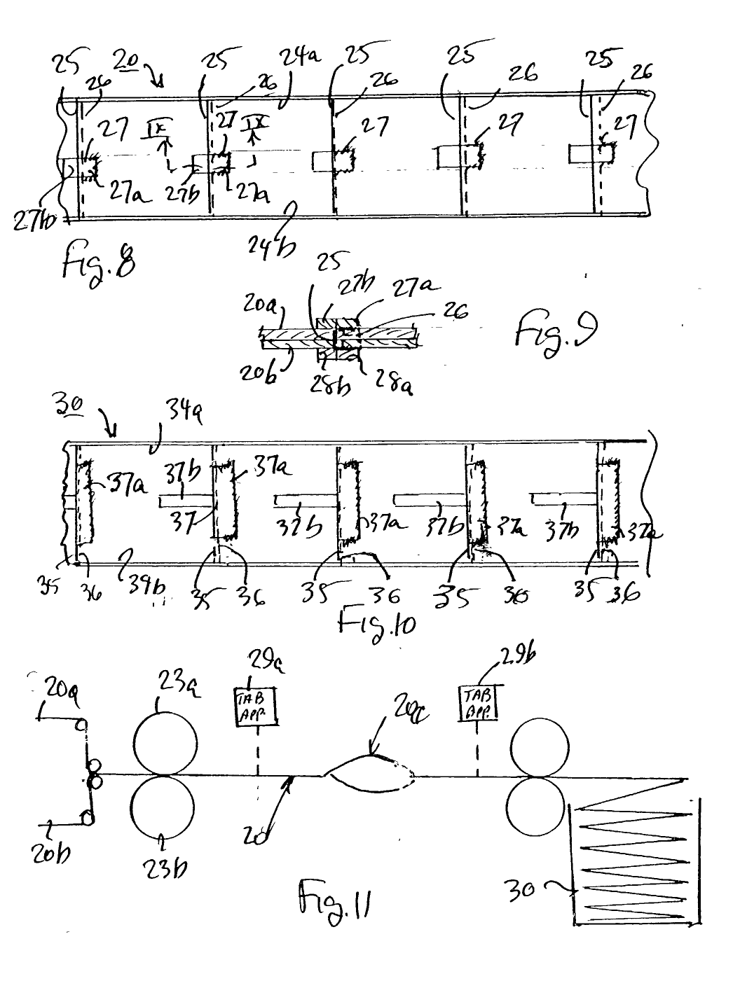

Thus, as shown in FIG. 5, the two plastic films 10a, 10b to be used in making the continuous strip, therein generally designated 10, are fed through separate drums 11a, 11b, respectively, having outer surfaces shaped to produce the cut lines defining the finger tabs 17a, 17b in the films, corresponding to finger tabs 7a and 7b in the FIGS. 1-4 embodiment. However, since in the FIGS. 7 embodiment the finger tabs 17a, 17b are not to be completely aligned, the two groups of feeding drums 11a, 11b are designed so as to produce the cut lines defining the two finger tabs 17a, 17b in a displaced relationship to each other. In FIG. 6a they are slightly displaced so as to be superposed in a partially-overlapping relation as they are fed to the drums 13a, 13b; whereas in FIG. 6b, the two finger tabs 17a, 17b are more displaced so as to be superposed in a non-overlapping relation as they are fed to the drums. The drums bond the two films together along the longitudinal bond lines 14a, 14b, the transverse bond lines 15, and the transverse severance lines 16 (FIG. 6).

The feeding drums 11a, 11b may also apply coloring matter to the finger tabs 17a, 17b to better enable the user to see the tabs and to grasp them for opening the respective bag after severed from the continuous strip.

It will be appreciated that while the continuous strip in the embodiments of FIGS. 1-7 is constructed of two films seamed at their opposite edges, they could also be constructed of a single film folded along one edge and seamed along the opposite edge, or by a seamless tube such as produced by an extrusion or air-blowing technique now commonly used in making thin plastic bags.

The Embodiments of FIGS. 8-11

FIGS. 8-11 illustrate two further embodiments of the invention wherein the finger tabs, instead of being integrally formed by cut lines in the plastic films as described above with respect to FIGS. 1-7, are separate elements bonded to the continuous strip.

Thus, the continuous strip, therein generally designated 20, is made by bonding two plastic films 20a, 20b (FIGS. 9, 11) together by means of drums 23a, 23b (FIG. 11) constructed so as to bond the outer edges of the two films by two longitudinal bond lines 24a, 24b (FIG. 8) and a plurality of longitudinally-spaced transverse bond lines 25, and to form a transverse severance line 26 adjacent to one side of each bond line 25, as described above with respect to FIGS. 1-7.

In this case, however, the finger tabs are not integrally formed by cut lines in the plastic films of the continuous strip, but rather are separate elements bonded to the opposite sides of the continuous strip.

A pair of finger tabs, generally designated 27, 28, are provided for each of the severable plastic bags in the continuous strip. Finger tab 27 includes a first section 27a bonded to plastic film 20a on one side of the respective transverse bond line 25 and transverse severance line 26, and a second section 27b extending over the respective transverse severance line 26 and bond line 25 and unbonded to its plastic film 20a. The other finger tab 28 carried by the other plastic film 20b also includes a bonded section 28a similarly bonded to its plastic film 20b, and an unbonded section 28b similarly extending over the respective transverse bond lines 25.

It will thus be seen that when a plastic bag section is severed along its respective transverse severance line 26, the unbonded sections 27b, 28b of the respective pair of finger tabs 27, 28 project outwardly of the respective end of the severed plastic bag, thereby enabling a user, by grasping the projecting tab sections 27b, 28b, to pull-apart the plastic films 20a, 20b at the respective end of the plastic bag, and thereby to fully open the plastic bag in a quick and convenient manner.

In the construction illustrated in FIGS. 8 and 9, the two sections 27a, 27b and 28a, 28b of the finger tabs 27, 28 are of approximately the same length, since the finger tabs are used only for locating the open end of the severed bag and for fully-opening that end by pulling the tabs apart.

FIG. 10 illustrates a variation wherein the unbonded sections, shown at 37b, of the tabs 37, are substantially longer and narrower than the bonded sections 37a. Such a construction enables each pair of finger tabs also to be used as tie cords for closing the open top of the plastic bag after severed and used.

FIG. 11 diagrammatically illustrates an apparatus similar to that of FIG. 1 for producing the constructions of FIGS. 8-10. Thus, the plastic films 20a, 20b, after bonded together by the drums 23a, 23b, pass through a station wherein a tab applicator 29a applies the tabs (e.g., tab 27), on one face of the continuous strip. The continuous strip is then half-twisted, as shown at 20c, to enable another tab applicator 29b to apply the other tabs 28 on the opposite face of the continuous strip. It will be appreciated that the two tabs 29a, 29b could also be applied at the same station from opposite sides of the continuous strip. The continuous strip may then be wound on a take-up drum (not shown), or introduced in fan-fold form into a container, as shown at 30.

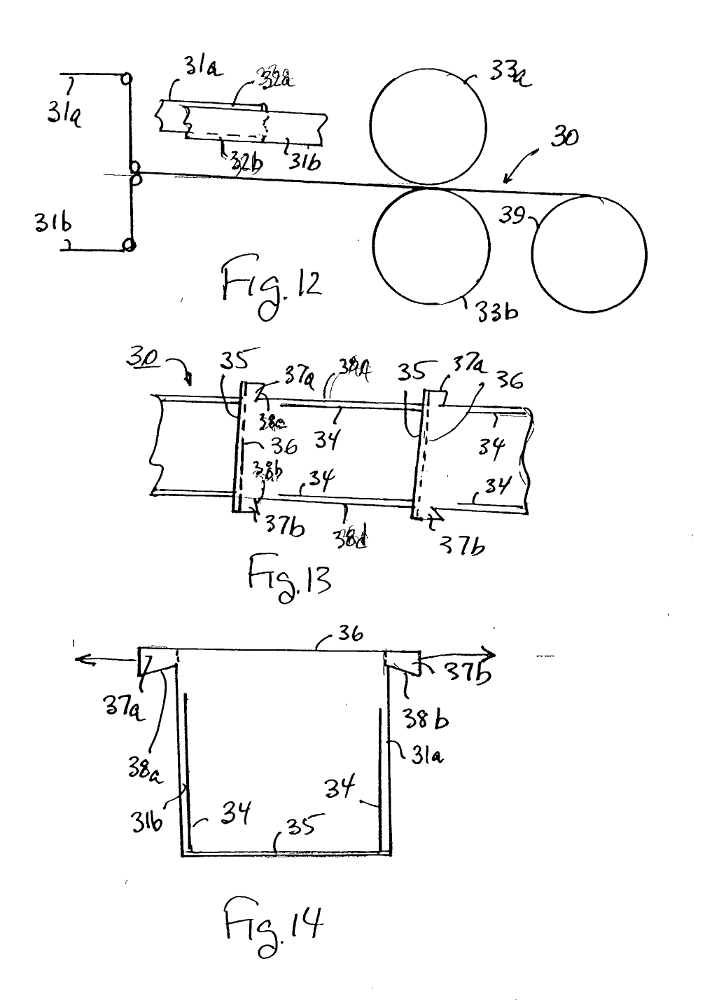

The Embodiment of FIGS. 12-15

FIGS. 12-15 illustrate an embodiment wherein each pair of the finger tabs for each unsevered plastic bag is formed to project laterally, rather than axially, from the opposite longitudinal edges at the open top of the respective plastic bag when severed from the continuous strip. Such a construction better facilitates (1) locating the severance line of a plastic bag to be severed from the continuous strip, (2) locating the top of the severed bag for opening it, and (3) the actual opening of the severed plastic bag.

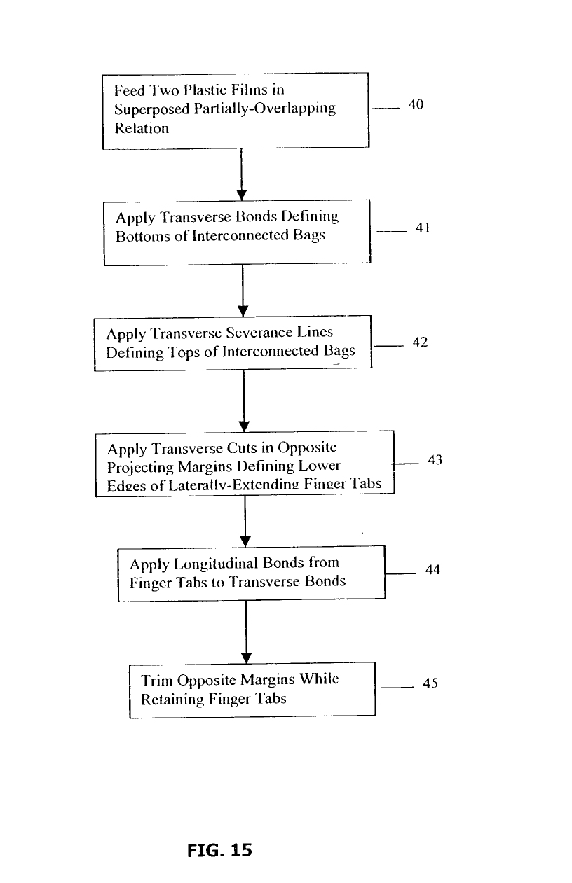

In this construction, the continuous strip, generally designated 30, is made of two plastic films, shown at 31a, 31b. These plastic films are fed in a superposed, partially overlapping relation, such that film 31a defines a first lateral margin 32a projecting laterally along one longitudinal edge of the continuous strip 30, and plastic film 31b defines a second lateral margin 32b projecting laterally along the opposite longitudinal edge of the continuous strip, as shown in FIG. 12. The two strips 31a, 31b are received by the processing drums 33a, 33b in this partial overlapping relationship, and are processed by the drums in the manner shown in the flow diagram of FIG. 15.

Thus, as shown in the flow diagram of FIG. 15, after the two plastic films 31a, 31b in the illustrated superposed partially-overlapping relationship (block 40) are received by the processing drums 33a, 33b, the latter drums apply the transverse bond lines 35 which define the bottoms of the interconnected bags (block 41); and the transverse severance lines 36 defining the tops of the interconnected bags (block 42). The two drums 33a, 33b also produce the tabs 37a, 37b (FIGS. 13, 14) in the margins 32a, 32b by applying transversely-extending cut lines 38a, 38b in these margins to define the inner edges of the finger tabs 37a, 37b (block 43). The longitudinal bond lines 34, are then applied, starting from a point slightly spaced from the transversely-extending cut lines 38a, 38b, to the transverse bond lines 35 of the respective plastic bag in the continuous strip. Finally, longitudinally-extending cut lines 38c, 38d, are applied from the transversely-extending cut lines 38a, 38b to the transversely-extending severance lines 36 of the respective plastic bags, to remove the excess of the margins 32a, 32b leaving the finger tabs 37a, 37b integrally formed with their respective plastic films 31a, 31b.

FIG. 14 illustrates one such plastic bag after having been severed from the continuous strip 30, wherein it will be seen that each of the finger tabs 37a, 37b is integrally formed at one lateral edge of its respective plastic film 31a, 31b, and is free at its opposite edge with respect to the other plastic film. FIG. 14 also illustrates the transverse bond line 35 defining the bottom of the plastic bag, and the longitudinal bond lines 34 bonding the side edges of the plastic bag, such that the open top of the plastic bag is defined by the severance line 36 along which the bag was severed from the continuous strip 30.

The laterally-projecting finger tabs 37a, 37b thus aid the user in locating the severance line 36 for severing the plastic bag from the continuous strip 30. They also aid the user in locating the open top of the severed bag to be opened. Further, they facilitate the opening of the severed bag by merely grasping the two finger tabs 37a, 37b, and pulling them apart, preferably with a snap action. Forming the cut lines 38a, 38b, defining the lower edges of the finger tabs 37a, 37b, at an acute angle to the upper edge of the finger tabs tends to concentrate the pull-apart force along the open top of the bag.

It may be desired, particularly in large-size plastic bags, not to remove the excess of the margins 32a, 32b but to retain them and use them as tie cords for tying closed the open end of the bag. In this case, the margins 32a, 32b would not be provided with the transverse cut lines 38a, 38b; also the cut lines 31a, 31b would be in the form of weakened severance lines such that the excess of the margins would not be removed, but rather would be retained with the laterally projecting finger tabs 37a, 37b, and used, if desired, as tie cords by severing along the later severance lines 31a, 31b.

The Embodiments of FIGS. 16-19

FIGS. 16-18 illustrate a still further embodiment of the invention in which the continuous strip of severable plastic bags may also be formed from a seamless tube with the finger tabs integrally formed therein as in FIGS. 1-7. In this embodiment, the finger tabs, integrally formed with the plastic film, are bent over the opposite outer faces at the open end of the bag when severed from the continuous strip, to facilitate the opening of the bag after severed from the continuous strip.

FIG. 16 diagrammatically illustrates one type of apparatus that may be used for making such a continuous strip of severable bags. The illustrated apparatus, generally designated 50, also receives a continuous strip 52 in the form of a flattened, hollow, tubular structure, which may be unseamed or seamed as described above. The continuous strip 52 is passed between a pair of forming members, namely drums 53a, 53b, which produce the longitudinal bond lines 54 (this being optional), the transverse bond lines 55, the transverse severance lines 56, and the finger tabs 57 defined by a transverse cut line 58 through a mid-portion of the continuous strip, and a pair of parallel, spaced longitudinal cut lines 59, 60. The longitudinal cut lines 59, 60, are joined at one end to the opposite ends of the transverse cut line 58. The opposite ends of the longitudinal cut lines 59, 60 define a connecting web 61 joining the tabs to the continuous strip 52 as described above.

In this case, however, the apparatus further includes a pair of deflectors 62a, 62b on the downstream side of the two forming drums 53a, 53b, effective to engage the free ends of the tabs 57 and to bend them over towards the continuous strip. Preferably, each forming drum 53a, 53b is provided with suction openings at the regions of the drums producing the cut lines 58, 59, 60, defining the finger tabs 57, so that during the rotation of the drums, the finger tabs tend to adhere to the respective drum, and thereby bend away from the continuous strip, until the deflectors 62a, 62b engage the tabs and bend them over towards the outer faces of the continuous strip.

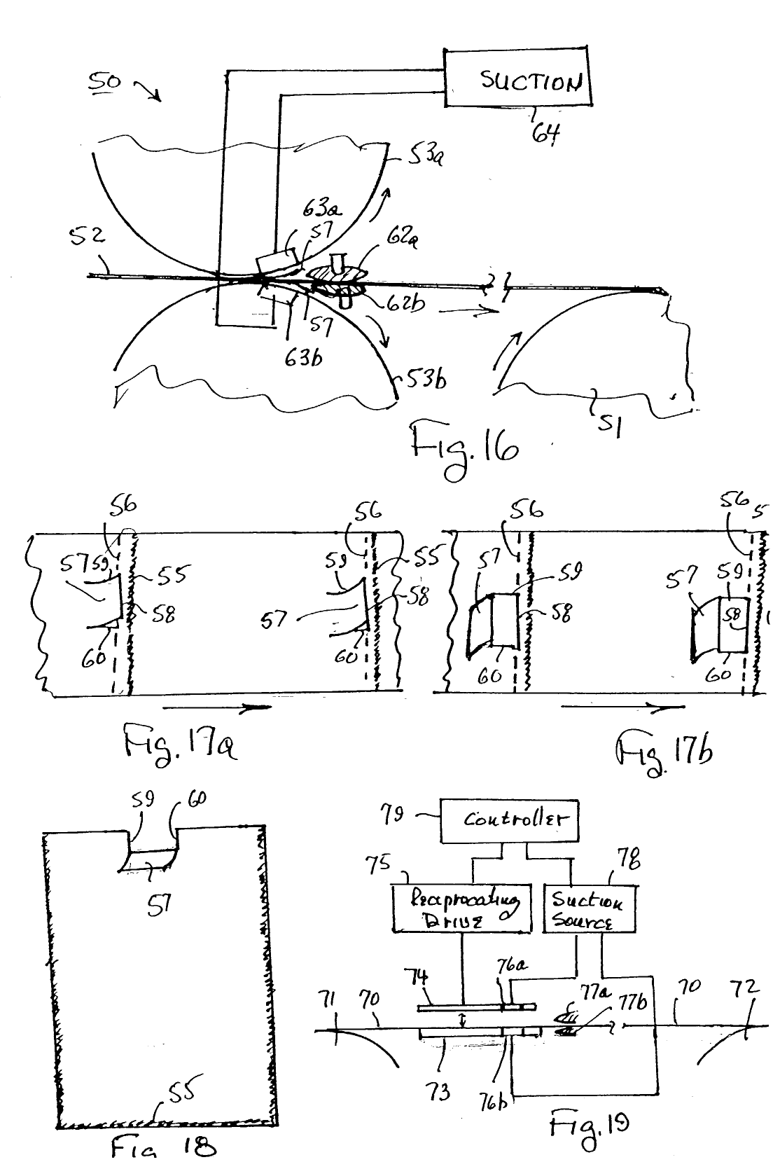

FIG. 17a diagrammatically illustrates the tabs 57 just before engagement by the deflectors 62a, 62b; whereas FIG. 17b illustrates the position of the tab 57 at point B, i.e., after deflection by the deflectors 62a, 62b.

It will be seen that the so-produced continuous strip of severable plastic bags, when unwound from a roll, enables the user to readily see the severance lines 56 for severing a bag, and also facilitates the severing of a bag from the continuous strip along the severance lines 56 and the cut lines 58 defining the tabs 57. The cut-out or space produced by the tabs when bent-over also enables the user to readily locate the severance lines, and the end of the severed bag to be opened, while the tabs 57 at the open end of the severed bag facilitate the opening of the bag. FIG. 18 illustrates such a severed bag ready for opening.

Depending on the length of the tabs 57, a suction may not be necessary to cause the initial deflection of the tabs from the continuous strip before engaged by the deflectors 62a, 62b, since the tabs, after the cut lines 58-60 are formed, inherently tend to adhere to the respective drum 53a, 53b; also the linear velocity of the continuous strip further tends to produce this initial deflection of the tabs. However, to assure this deflection, suction openings, as shown at 63a, 63b in FIG. 16, connected to a suction source diagrammatically shown at 64, may be provided on the inner surfaces of the drums in the regions thereof to form the tabs 57.

The tabs 57, after bent-over as described above, would tend to adhere to the outer faces of the plastic film, particularly if the film is very thin. However, such tabs are readily observable, particularly because of the cut-outs they leave at the upper edges of the severed bag, and are readily movable away from the plastic film, e.g., by the user's finger nails, for grasping and pulling apart to open the bag.

FIG. 19 illustrates apparatus similar to that of FIG. 16, but instead of using rotatable drums as the forming members, the apparatus of FIG. 19 includes a reciprocating plate overlying the continuous strip and a fixed plate underlying the continuous strip.

Thus, as shown in FIG. 19, the continuous strip, therein designated 70, is continuously fed from a supply roll 71 to a take-up roll 72 over a fixed plate or table 73. The continuous strip 70 is formed with the bond lines 55, severance lines 56, and cut lines defining the tabs 57, as described above with respect to FIGS. 16-18, by a reciprocating plate 74 overlying the continuous strip 70 and reciprocated by a drive 75 towards and away from the fixed plate or table 73 underlying the continuous strip 70. Such apparatus may be, for example, that described in U.S. Pat. No. 5,637,184, the disclosure of which is incorporated herein by reference.

However, the apparatus illustrated in FIG. 19 also includes the suction openings 76a, 76b in the reciprocating plate 74 and fixed plate 73, respectively, corresponding to suction openings 63a, 63b in FIG. 16; it also includes the deflectors 77a, 77b, corresponding to deflectors 62a, 62b in FIG. 16, to deflect the tabs (57, FIG. 18) outwardly as described above. The suction openings 76a, 76b are connected to a suction source 78, which suction source is controlled by a controller 79 in synchronism with the reciprocating drive 75.

While the invention has been described with respect to several preferred embodiments, it will be appreciated that these are set forth merely for purposes of example, and that many other variations, modifications and applications of the invention may be made.

What is claimed is:

1. A continuous strip of individually severable plastic bags each having a closed bottom and an open top when severed, comprising:
a flattened, hollow, tubular structure of plastic film formed with a plurality of transversely-extending, longitudinally-spaced bond lines to define the closed bottoms of the plastic bags when individually severed from the continuous strip;
said flattened, hollow, tubular structure also being formed with a transversely-extending severance line on one side of each transversely-extending bond line to permit severance of an individual bag from the continuous strip, and to define the open top of the plastic bag severed from the continuous strip;
and a pair of finger tabs carried by said continuous strip adjacent each of said transversely-extending severance lines to facilitate opening each plastic bag when severed from the continuous strip.

2. The continuous strip according to claim 1, wherein said finger tabs are integrally formed with said plastic film.

3. The continuous strip according to claim 1, wherein each pair of said finger tabs is formed to extend axially of the open top of the respective bag when severed from the continuous strip.

4. The continuous strip according to claim 3, wherein each of said finger tabs is bent-over towards the outer face of the end of each plastic bag to constitute the open end of the bag when severed from the continuous strip.

5. The continuous strip according to claim 4, wherein each of said finger tabs is defined by a transverse cut line through a mid-portion of its respective plastic bag, and by a pair of parallel, spaced longitudinal cut lines having one of their ends joined to the opposite ends of the transverse cut line, the opposite ends of said longitudinal cut lines defining a connecting web along which said tabs are bent-over towards the outer faces of their respective plastic bags.

6. The continuous strip according to claim 5, wherein said transverse severance lines permitting severance of the individual bags from the continuous strip are aligned with said transverse cut lines of the tabs, such that said tabs when bent-over are recessed inwardly from the end of the respective bag constituting the open end of the bag when the bag is severed from the continuous strip.

7. The continuous strip according to claim 1, wherein each pair of said finger tabs is formed to project laterally from the opposite longitudinal edges of the continuous strip at the open top of the respective bag when severed from the continuous strip.

8. The continuous strip according to claim 7, wherein said flattened hollow tubular structure is defined by two plastic films bonded together at their opposite longitudinal edges by longitudinally-extending bond lines; one of said finger tabs of each pair being integrally formed with one plastic film and projecting laterally outwardly of one of said longitudinal edges; the other of said finger tabs of each pair being integrally formed with the other plastic film and projecting laterally outwardly of the opposite longitudinal edge of the continuous strip.

9. The continuous strip according to claim 1, wherein said finger tabs are separate elements bonded to said continuous strip.

10. The continuous strip according to claim 9, wherein the length of said unbonded section of each finger tab is relatively short to enable grasping for opening a severed plastic bag.

11. The continuous strip according to claim 9, wherein the length of said unbonded section of each finger tab is relatively long to enable each pair of finger tabs to be grasped for opening a severed plastic bag, and also to be used as tie cords for closing a severed plastic bag.

12. The continuous strip according to claim 1, wherein said finger tabs are differently colored from said plastic film to facilitate locating the finger tabs of a plastic bag when severed from the continuous strip.

13. A method of making a continuous strip of individually severable plastic bags, comprising:
forming a plurality of longitudinally-spaced transverse bond lines in a flattened, hollow, tubular structure of a plastic film, to define closed bottoms of plastic bags when individually severed from the continuous strip;
forming a transverse severance line on one side of each transverse bond line to permit severance of an individual bag, and to define the top edge of the next unsevered plastic bag in the continuous strip;
and providing a pair of finger tabs adjacent each of said severance lines to facilitate opening a plastic bag when severed from the continuous strip.

14. The method according to claim 13, wherein said finger tabs are integrally formed with said plastic film and are defined by cut lines therein.

15. The method according to claim 14, wherein each of said finger tabs is formed to extend axially of the respective transverse severance line.

16. The method according to claim 15, wherein said finger tabs are bent over the outer faces of the end of each plastic bag to constitute the open end of the bag when severed from the continuous strip.

17. The method according to claim 16, wherein each of said finger tabs is defined by a transverse cut line through a mid-portion of its respective plastic bag, and by a pair of parallel, spaced longitudinal cut lines having one of their ends joined to the opposite ends of the transverse cut line, the opposite ends of said longitudinal cut lines defining a connecting web along which said tabs are bent-over the outer faces of their respective plastic bags.

18. The method according to claim 17, wherein said severance lines permitting severance of the individual bags from the continuous strip are aligned with said transverse cut lines of the tabs, such that said tabs when bent-over are recessed inwardly from the end of the respective bag constituting the open end of the bag when the bag is severed from the continuous strip.

19. The method according to claim 17, wherein suction is applied to each side of the continuous strip in the area thereof defined by said finger tabs, after the continuous strip is cut by said transverse cut lines, to cause the finger tabs to bend over the outer faces of the end of each plastic bag to constitute the open end of the bag when severed from the continuous strip.

20. The method according to claim 19, wherein said transverse bond lines, transverse severance lines, transverse cut lines, and longitudinal cut lines are all formed by forming members between which the continuous strip is fed, said suction being applied through the regions of the forming members producing the transverse and longitudinal cut lines defining said finger tabs.

21. The method according to claim 20, wherein said forming members are a pair of rotatable drums between which the continuous strip is fed.

22. The method according to claim 20, wherein said forming members include a reciprocating plate overlying the continuous strip, and a fixed plate underlying the continuous strip.

23. The method according to claim 13, wherein said finger tabs are separate elements bonded to said continuous strip.

24. The method according to claim 13, wherein said flattened hollow tubular structure is defined by two plastic films bonded together at their opposite longitudinal edges by longitudinally-extending bond lines; one of said finger tabs of each pair being integrally formed with one plastic film and projecting laterally outwardly of one of said longitudinal edges; the other of said finger tabs of each pair being integrally formed with the other plastic film and projecting outwardly of the opposite longitudinal edge of the continuous strip.

25. The method according to claim 24, wherein the two plastic films are bonded together in a superposed, partially-overlapping relationship, to define a first lateral margin constituted by one plastic film projecting laterally along one longitudinal edge of the continuous strip, and a second lateral margin constituted by the other plastic film projecting laterally along the opposite longitudinal edge of the continuous strip; said finger tabs of each pair being formed by transversely-extending cut lines in said first and second margins defining the inner edges of said finger tabs, and by longitudinally-extending cut lines removing the remainders of said margins, except for the finger tabs, from the continuous strip.

26. Apparatus for producing continuous strips of individually severable plastic bags, comprising:
a pair of forming members spaced from each other to engage the opposite faces of a flattened, hollow, tubular structure fed as a continuous strip between the forming members;
the outer surfaces of said forming members being constructed to form:
a plurality of transversely-extending longitudinally-spaced bond lines to define closed bottoms of the plastic bags when individually severed from the continuous strip;
a transversely-extending severance line on one side of each transversely-extending bond line to permit severance of an individual bag from the continuous strip, and to define the open top of the plastic bag severed from the continuous strip;
and a pair of finger tabs carried by said continuous strip adjacent each of said transversely-extending severance lines to facilitate opening each plastic bag when severed from the continuous strip.

27. The apparatus according to claim 26, wherein confronting surfaces of said forming members are formed, in the areas thereof producing said finger tabs, with suction openings connected to a source of suction for releasably adhering said finger tabs against the respective forming member as the strip is fed between the forming members, and thereby for deflecting said finger tabs away from said continuous strip as the strip exits from between said forming members.

28. The apparatus according to claim 27, wherein said apparatus further includes a pair of deflectors straddling said continuous strip immediately downstream of said forming members for deflecting said finger tabs back towards the outer faces of said continuous strip.

29. The apparatus according to claim 26, wherein said forming members are drums rotatably mounted along parallel axes.

30. The apparatus according to claim 26, wherein said forming members include a reciprocating plate overlying the continuous strip, and a fixed plate underlying the continuous strip.

31. A plastic bag open at one end and having, at said open end, a pair of finger tabs to facilitate opening the plastic bag.

32. The plastic bag according to claim 31, wherein said finger tabs are integrally formed of the same material as said plastic bag.

33. The plastic bag according to claim 31, wherein said finger tabs are separate elements attached to the open end of said plastic bag.

34. The plastic bag according to claim 31, wherein said finger tabs project axially of the open end of the plastic bag.

35. The plastic bag according to claim 31, wherein said finger tabs are bent-over the open end of the plastic bag.

36. The plastic bag according to claim 31, wherein said finger tabs project laterally from the opposite longitudinal edges at the open end of the plastic bag.
